(19) United States
(12) Patent Application Publication
(10) Pub. No.: US 2015/0172630 A1
(43) Pub. Date: Jun. 18, 2015

(54) SCANNER

(71) Applicants: XYZprinting, Inc., New Taipei City (TW); Kinpo Electronics, Inc., New Taipei City (TW); Cal-Comp Electronics & Communications Company Limited

(72) Inventor: Wen-Chieh Hsieh, New Taipei City (TW)

(73) Assignees: XYZprinting, Inc., New Taipei City (TW); Cal-Comp Electronics & Communications Company Limited, New Taipei City (TW); Kinpo Electronics, Inc., New Taipei City (TW)

(21) Appl. No.: 14/217,505

(22) Filed: Mar. 18, 2014

(30) Foreign Application Priority Data
Dec. 13, 2013 (TW) 102146215

(51) Int. Cl. H04N 13/02

(52) U.S. Cl. CPC H04N 13/0217

(57) ABSTRACT

A scanner includes a rotary platform having a carrying surface, a support rack, an adjustment mechanism, a sensing device, and a control unit. The rotary platform is at one end of the support rack. The adjustment mechanism is at the other end of the support rack. The sensing device is arranged on the adjustment mechanism to generate a first or second sensing signal when the sensing device rotates to a first location. The control unit is coupled to the sensing device, the adjustment mechanism, and the rotary platform to rotate the rotary platform according to the first sensing signal, drive the sensing device to perform 3-D scanning on an object, or control the adjustment mechanism to drive the sensing device to rotate by a specific angle according to the second sensing signal, so that the sensing device faces the carrying surface to perform 2-D scanning on the object.

### CROSS-REFERENCE TO RELATED APPLICATION

This application claims the priority benefit of Taiwan application serial no. 102146215, filed on Dec. 13, 2013. The entirety of the above-mentioned patent application is hereby incorporated by reference herein and made a part of this specification.

### BACKGROUND

1. Technical Field

The invention relates to a scanner, and more particularly, to a scanner capable of performing a three-dimensional (3-D) scanning task and a two-dimensional (2-D) scanning task.

2. Description of Related Art

Along with the progress of computer technology and the development of multimedia technology, computers have gradually become indispensable tools in people's daily lives, and the rapid development of the image processing technique leads to the advance of peripheral image processors, such as three-dimensional (3-D) scanners.

In a normal two-dimensional (2-D) scanner, the scanning module often includes an optical sensor for capturing an image of a to-be-scanned object. Every time after a scanning job is completed, the scanning module is required to return to a home position and wait for the next scanning job. The existing 3D model scanning technique mainly includes two core steps of “shooting” and “merging” images of an object. For instance, in the “shooting” step, a shooting angle of the object has to cover all possible angles as far as possible in order to guarantee integrity of the resultant images. After the “shooting” step is completed, the “merging” step is executed to merge the images captured at different angles into a 3-D model.

One of the existing techniques is to record a rotation angle of a turntable corresponding to a shooting moment by means of a single camera and the turntable and merge the shooting results obtained by the camera at each angle to build the 3-D model of the object. Another existing technique is to set a plurality of cameras to cover all of the shooting angles and simultaneously obtain the shooting results of the object. Since locations of the cameras are all fixed, once the location and the shooting direction of each camera are obtained, the shooting data of the cameras can be merged to build the 3-D model of the object.

Unfortunately, most of the existing scanners can merely perform either the 2-D scanning job or the 3-D scanning job, and thus the development of the scanner capable of performing both the 2-D scanning job and the 3-D scanning job is one of the research topics in the pertinent field.

### SUMMARY

The invention is directed to a scanner that can be automatically switched between a two-dimensional (2-D) scanning mode and a three-dimensional (3-D) scanning mode after detecting an object and determining whether the object is a 2-D object or a 3-D object.

In an embodiment of the invention, a scanner adapted to perform a 2-D scanning task or a 3-D scanning task on an object is provided. The scanner includes a rotary platform, a support rack, an adjustment mechanism, a sensing device, and a control unit. The rotary platform has a carrying surface and is arranged to rotate about a rotation axis. The object is adapted to be arranged on the carrying surface. The rotary platform is located at one end of the support rack. The adjustment mechanism is located at the other end of the support rack opposite to the end of the support rack where the rotary platform is located. The sensing device is arranged on the adjustment mechanism to perform a sensing action and generate a first sensing signal or a second sensing signal. The control unit is coupled to the sensing device, the adjustment mechanism, and the rotary platform to drive the rotary platform to rotate according to the first sensing signal, to drive the sensing device to perform the 3-D scanning task on the object, or to control the adjustment mechanism to drive the sensing device to rotate by a specific angle according to the second sensing signal, such that the sensing device faces the carrying surface to perform the 2-D scanning task on the object.

In view of the above, the sensing device is rotatably configured on top of the rotary platform to perform the sensing action and generate the first or second sensing signal. According to the first sensing signal, the control unit drives the rotary platform to rotate and drives the sensing device to perform the 3-D scanning task on the object. According to the second sensing signal, the control unit controls the sensing device to rotate to face the rotary platform, so as to perform the 2-D scanning task on the object. Hence, the scanner provided herein is able to automatically detect the object and determine whether the object is a 3-D object or a 2-D object, so as to perform the corresponding 3-D or 2-D scanning task. As a result, the use of the scanner is much more convenient.

Several exemplary embodiments accompanied with figures are described in detail below to further describe the invention in details.

### BRIEF DESCRIPTION OF THE DRAWINGS

FIG. 1 is a schematic block diagram illustrating a portion of a scanner according to an embodiment of the invention.

FIG. 2 is a schematic diagram illustrating an image capturing device of a scanner at a first location according to an embodiment of the invention.

FIG. 3 is a schematic diagram illustrating an image on a screen according to an embodiment of the invention.

FIG. 4 is a schematic diagram illustrating another image on a screen according to an embodiment of the invention.

FIG. 5 is a schematic diagram illustrating an image capturing device of a scanner at a second location according to an embodiment of the invention.

FIG. 6 is a schematic diagram illustrating an image capturing device of a scanner at a first location according to another embodiment of the invention.

FIG. 7 is a schematic diagram illustrating an image capturing device of a scanner at a second location according to another embodiment of the invention.

### DETAILED DESCRIPTION OF DISCLOSED EMBODIMENTS

It is to be understood that the foregoing and other detailed descriptions, features, and advantages are intended to be described more comprehensively by providing embodiments accompanied with figures hereinafter. In the following embodiments, wordings used to indicate directions, such as “up,” “down,” “front,” “back,” “left,” and “right”, merely refer to directions in the accompanying drawings. Thus, the language used to describe the directions is not intended to limit the scope of the invention. Moreover, in the following embodiments, identical or similar components share the identical or similar reference numbers.

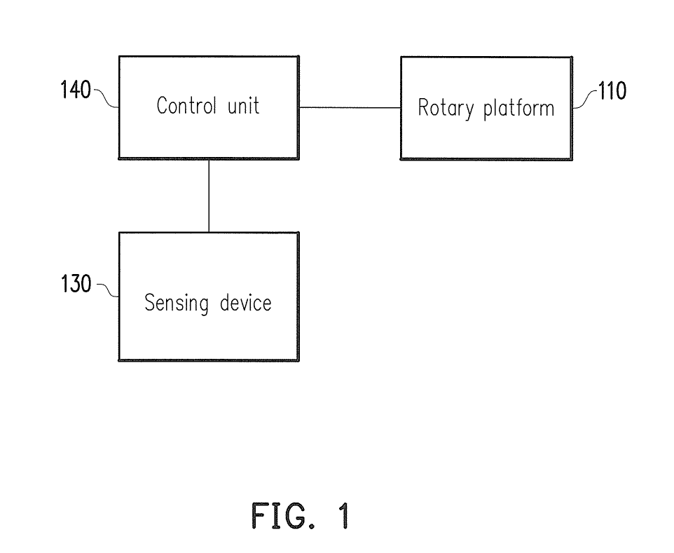

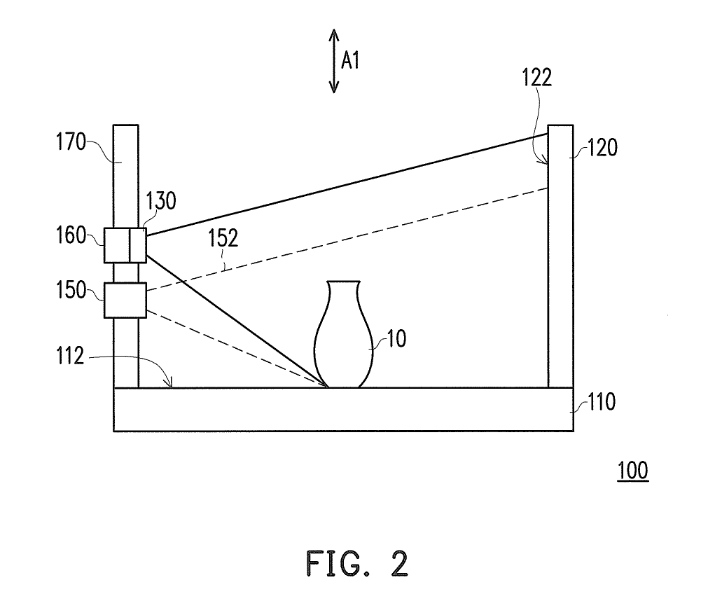

FIG. 1 is a schematic block diagram illustrating a portion of a scanner according to an embodiment of the invention. FIG. 2 is a schematic diagram illustrating an image capturing device of a scanner at a first location according to an embodiment of the invention. With reference to FIG. 1 and FIG. 2, in the present embodiment, the scanner 100 is adapted to detect an object 10, so as to determine whether a 2-D scanning task or a 3-D scanning task is to be performed on the object 10. If the scanner 100 determines that the object 10 is a 2-D object, the 2-D scanning task may be performed on the object 10, so as to generate a digital 2-D scan file. If the scanner 100 determines that the object 10 is a 3-D object, a 3-D model building process may be performed on the object 10, so as to generate a digital 3-D model associated with the object 10. Besides, the scanner 100 may be coupled to, for instance, a 3-D printing apparatus, such that the 3-D printing apparatus reads the digital 3-D model and prints a copy of the object 10 according to the digital 3-D model. Certainly, the scanner 100 may also be coupled to, for instance, a 2-D printing apparatus, such that the 2-D printing apparatus reads the digital 2-D scan file and prints a copy of the 2-D object 10 according to the digital 2-D scan file.

Specifically, the scanner 100 includes a rotary platform 110, a support rack 170, an adjustment mechanism 160, a sensing device 130, and a control unit 140. The rotary platform 110 has a carrying surface 112 and is arranged to rotate about a rotation axis A1. The to-be-scanned object 10 is adapted to be arranged on the carrying surface 112. The rotary platform 110 is located at one end of the support rack 170, and the adjustment mechanism 160 is located on the other end of the support rack 170 opposite to the end of the support rack 170 where the rotary platform 110 is located. Namely, the rotary platform 110 and the adjustment mechanism 160 are respectively located at two opposite ends of the support rack 170. The sensing device 130 is arranged on the adjustment mechanism 160 for sensing the object 10 and generates a first sensing signal or a second sensing signal. The control unit 140 is coupled to the sensing device 130 and the rotary platform 110 to drive the rotary platform 110 to rotate according to the first sensing signal, to drive the sensing device 130 to perform the 3-D scanning task on the object 10, or to control the adjustment mechanism 160 to drive the sensing device 130 to rotate by a specific angle according to the second sensing signal, such that the sensing device 130 faces the carrying surface 112 to perform the 2-D scanning task on the object 10.

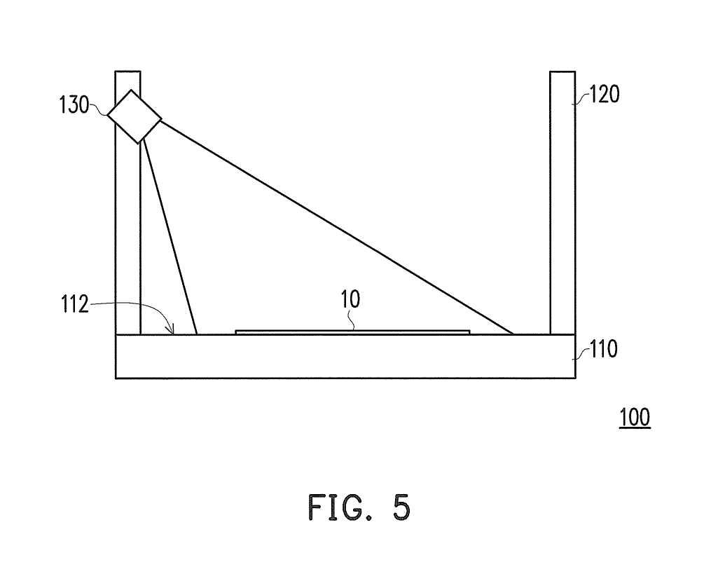

According to the present embodiment, the scanner 100 further includes a screen 120 located at one side of the rotary platform 110. Particularly, the screen 120 and the support rack 170 are respectively located at two opposite sides of the rotary platform 110 and are independent from each other without being rotated together with the rotary platform 110. As shown in FIG. 2, the screen 120 may include a projection surface 122 that is perpendicular to the carrying surface 112. The sensing device 130 is driven by the adjustment mechanism 160 and rotated between a first location shown in FIG. 2 and a second location shown in FIG. 5. The control unit 140 is coupled to the adjustment mechanism 160 to control the adjustment mechanism 160 to drive the sensing device 130 to rotate. Thereby, when the sensing device 130 rotates to the first location, the sensing device 130 faces the screen 120, as shown in FIG. 2. When the sensing device 130 rotates to the second location, the sensing device 130 faces the rotary platform 110.

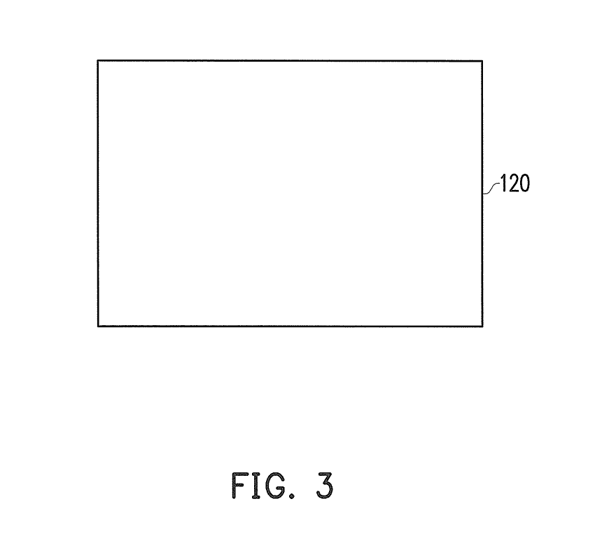

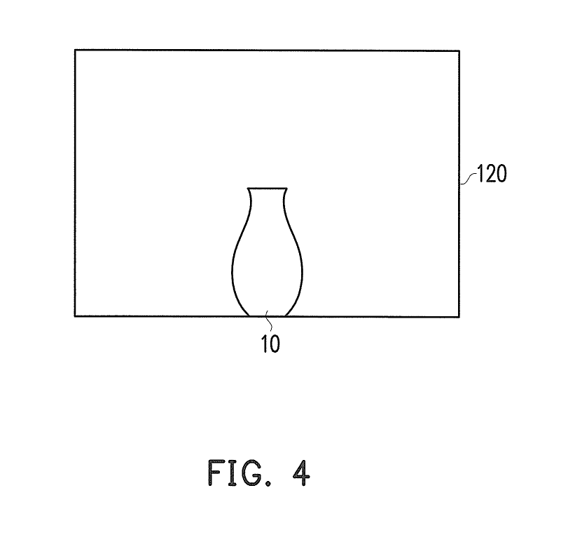

FIG. 3 is a schematic diagram illustrating an image on a screen according to an embodiment of the invention. FIG. 4 is a schematic diagram illustrating an image on a screen according to an embodiment of the invention. With reference to FIG. 2 to FIG. 4, in the present embodiment, the control unit 140 is coupled to the sensing device 130 and the rotary platform 110. When the object 10 is located on the carrying surface 112 of the rotary platform 110, if the object 10 is a 3-D object with a relatively significant thickness, as shown in FIG. 2, the object 10 blocks a portion of the screen 120, such that the image of the screen 120 sensed by the sensing device 130 is changed from the image shown in FIG. 3 to the image shown in FIG. 4. That is, if the object 10 is a 3-D object, the image of the screen sensed by the sensing device 130 is changed; namely, if the sensing device 130 senses a change to the image of the screen 120, it is indicated that the object 10 is a 3-D object. At the time, the sensing device 130 generates the first sensing signal, and the control unit 140 receives the first sensing signal and thereby drives the rotary platform 110 and the sensing device 130 to perform a 3-D scanning task on the object 10.

Particularly, the rotary platform 110 serves to carry the object 10 and is adapted to rotate the object 10 about the rotation axis A1 to plural orientations. When the sensing device 130 senses the change to the image of the screen 120, the control unit 140 drives the rotary platform 110 to rotate the object 10 to said orientations and controls the sensing device 130 to capture a plurality of images of the object 10 at said orientations, so as to establish a digital 3-D model associated with the object 10 according to the captured images of the object 10 corresponding to said orientations.

To be specific, the control unit 140 is able to control the rotary platform 110 to sequentially rotate by a plurality of predetermined angles about the rotation axis A1, such that the object 10 is sequentially rotated to said orientations. In addition, according to the present embodiment, the rotary platform 110 may, for instance, have an encoder configured to record the orientations to which the rotary platform 110 rotates, and the recorded orientations may be read by the control unit 140. Thereby, once the rotary platform 110 rotates the object 10 by a predetermined angle, the sensing device 130 captures the image of the rotated object 10. Said steps are repeated until the images of the object 10 at each predetermined angle are captured, and the control unit 140 then relates the images of the object 10 to the coordinates of said orientations, so as to build the digital 3-D model associated with the object 10.

In the present embodiment, the control unit 140 controls the rotary platform 110 to rotate by the predetermined angles about the rotation axis A1, and the sum of the predetermined angles is 180 degrees. That is, the rotary platform 110 each time rotates the object 10 by a predetermined angle until the object 10 rotates by 180 degrees in total. It should be mentioned that the predetermined angle by which the rotary platform 110 rotates each time is determined by the complexity of the surface silhouette of the rotary platform 110. If the surface silhouette of the rotary platform 110 is relatively complex, the predetermined angle by which the rotary platform 110 rotates each time may be set to be small, i.e., the sensing device 130 may generate more images of the object 10 in this case.

The object 10 is ideally placed at the center of the rotary platform 110, and thereby the center axis of the object 10 may be substantially coincided with the rotation axis A1 of the rotary platform 110. Hence, an initial image of the silhouette of the object 10 corresponding to an initial orientation of the object 10 on the rotary platform 110 is theoretically substantially overlapped with a final image of the silhouette of the object 10 corresponding to a final orientation of the object 10 rotated by 180 degrees.

However, as a matter of fact, the object 10 may not be placed in such an ideal manner, such that the center axis of the object 10 may not be coincided with the rotation axis A1 of the rotary platform 110. Thereby, the initial image of the object 10 corresponding to the initial orientation of the object 10 on the rotary platform 110 cannot be completely coincided with the final image of the object 10 corresponding to the final orientation of the object 10 rotated by 180 degrees. In this case, the control unit 140 may compare the initial image of the object 10 with the final image of the object 10, so as to obtain a real image of the object 10 at the orientation and also obtain a center axis of the images of the object 10.

According to another embodiment of the invention, the scanner 100 may further include a light source 150 configured to emit a light beam 152 in a direction parallel to the carrying surface 112. The screen 120 is arranged on a transmission path of the light beam 152. The rotary platform 110 is located between the light source 150 and the screen 120, such that the object 10 is located on the transmission path of the light beam 152 and blocks the transmission of the light beam 152, and that a shadow of the object 10 with clear contrast may be generated and shown on the screen 120. The size of the shadow is in fixed proportion to the size of the object. In the present embodiment, said fixed proportion may be substantially greater than 1. That is, the size of the shadow may be proportionally greater than the size of the object 10. The scanner 100 may determine the size proportion between the shadow and the object 10 by adjusting the distance from the light source 150 to the object 10 and the distance from the object 10 to the screen 120. Thereby, the shadow that is proportionally greater than the object 10 in size is fanned on the screen 120, such that the detailed silhouettes of the object 10 can be obtained.

When the sensing device 130 senses the change to the image of the screen 120 (which indicates that the object 10 is a 3-D object), the control unit 140 drives the rotary platform 110 and the sensing device 130 to perform the 3-D scanning task on the object 10. In particular, the control unit 140 drives the rotary platform 110 to rotate the object 10 to plural orientations, so as to form on the screen 120 a plurality of silhouettes of the object 10 corresponding to said orientations; at the same time, the control unit 140 controls the sensing device 130 to capture the images of the silhouette of the object 10 at said orientations, so as to establish the digital 3-D model associated with the object 10 according to the captured images of the silhouette of the object 10 corresponding to said orientations. In the present embodiment, the sensing device 130 is a charge coupled device (CCD). Certainly, the invention should not be construed as limited to the embodiment set forth herein. The sensing device 130 described in the present embodiment may be a monochrome sensing device, i.e., the image of the silhouette of the object obtained by the sensing device 130 is a monochrome image, so as to lessen the loading of the control unit 140 while the control unit 140 processes the images and perform relevant calculations.

In addition, when the object 10 is located on the carrying surface 112 of the rotary platform 110 in the scanner 100 described herein, if the object 10 is a 2-D object (e.g., a paper) of which the thickness may be ignored, as shown in FIG. 5, the screen 120 is not blocked by the object 10 due to the small thickness of the object 10, and thus the sensing device 130 senses no change to the image of the screen 120, i.e., the image of the screen stays the same as that shown on FIG. 3. That is, if the object 10 is a 2-D object, the sensing device 130 senses no change to the image of the screen 120; namely, when the object 10 is located on the rotary platform 110, and the sensing device 130 senses no change to the image of the screen 120 (which indicates that the object 10 is a 2-D object), the sensing device 130 generates the second sensing signal, and the control unit 140 receives the second sensing signal and thereby drives the sensing device 130 to rotate to the second location shown in FIG. 5, so as to perform a 2-D scanning task on the object 10. To be specific, when the object 10 is located on the rotary platform 110, and the sensing device 130 senses no change to the image of the screen 120, the control unit 140 drives the sensing device 130 to rotate to the second location shown in FIG. 5 and capture an image of the object 10, so as to build a digital 2-D scan file associated with the object according to the captured image of the object 10.

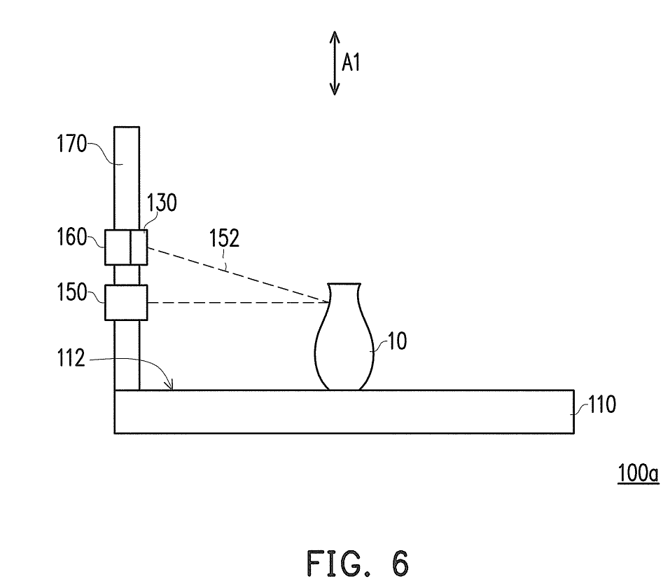

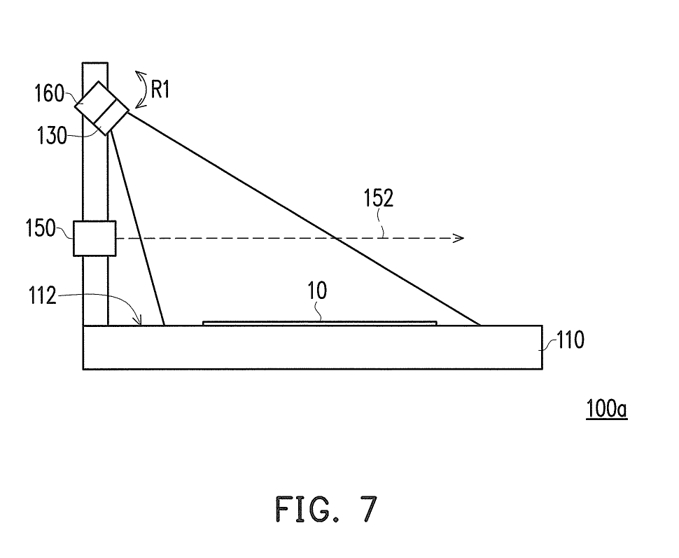

FIG. 6 is a schematic diagram illustrating an image capturing device of a scanner at a first location according to another embodiment of the invention. FIG. 7 is a schematic diagram illustrating an image capturing device of a scanner at a second location according to another embodiment of the invention. It should be mentioned that the scanner 100a described in the present embodiment is similar to the scanner 100 shown in FIG. 2 and FIG. 5, and therefore reference numbers and some descriptions provided in the previous exemplary embodiments are also applied in the following exemplary embodiment. The same reference numbers represent the same or similar components in these exemplary embodiments, and repetitive descriptions are omitted. The omitted descriptions may be referred to as those described in the previous embodiments and will not be again provided hereinafter. With reference to FIG. 1, FIG. 6, and FIG. 7, the differences between the scanner 100a provided in the present embodiment and the scanner 100 shown in FIG. 2 and FIG. 5 are described hereinafter.

As shown in FIG. 6, the scanner 100a described in the present embodiment may include a light source 150 configured to emit a light beam 152 in a direction parallel to the carrying surface 112. The light source 150 is located on the support rack 170; however, in the present embodiment, no screen 120 (shown in FIG. 2) is configured on the other end of the rotary platform 110. With such configuration, if the object 10 is a 3-D object with a relatively significant thickness, as shown in FIG. 6, the object 10 blocks the transmission of the light beam 152 when the object 10 is located on the rotary platfoini 110, such that the light beam 152 is reflected, and that the sensing device 130 may be configured to sense the reflected light beam 152. That is, if the object 10 arranged on the rotary platform 110 is a 3-D object, the sensing device 130 senses reflection of the light beam 152, i.e., if the sensing device 130 senses the reflection of the light beam 152 (which indicates that the object 10 is a 3-D object), the sensing device 130 generates the first sensing signal, and the control unit 140 receives the first sensing signal and thereby drives the rotary platform 110 and the sensing device 130 to perform a 3-D scanning task on the object 10.

Particularly, the rotary platform 110 serves to carry the object 10 and is adapted to rotate the object 10 about the rotation axis A1 to plural orientations. When the object 10 is arranged on the rotary platform 110, if the sensing device 130 senses the reflection of the light beam 152, the control unit 140 drives the rotary platform 110 to rotate the object 10 to said orientations and controls the sensing device 130 to capture a plurality of images of the object 10 at said orientations, so as to establish a digital 3-D model associated with the object 10 according to the captured images of the object 10 corresponding to said orientations.

By contrast, if the object 10 is a 2-D object (e.g., a paper) of which the thickness may be ignored, as shown in FIG. 7, the transmission of the light beam 152 is not blocked due to the small thickness of the object 10, and thus the light beam 152 continues to be transmitted along the direction parallel to the carrying surface 112 and is not reflected. That is, if the object 10 is a 2-D object, the sensing device 130 senses no reflection of the light beam 152; namely, when the object 10 is located on the rotary platform 110, and the sensing device 130 senses no reflection of the light beam 152 (which indicates that the object 10 is a 2-D object), the sensing device 130 generates the second sensing signal, and the control unit 140 receives the second sensing signal and thereby drives the sensing device 130 to rotate to the second location (shown in FIG. 7) along a rotation direction R1, so as to perform a 2-D scanning task on the object 10. To be specific, when the object 10 is located on the rotary platform 110, and the sensing device 130 senses no reflection of the light beam 152, the control unit 140 drives the sensing device 130 to rotate to the second location shown in FIG. 7 and capture an image of the object 10, so as to build a digital 2-D scan file associated with the object according to the captured image of the object 10.

To sum up, the sensing device described in an embodiment of the invention is rotatably configured on top of the rotary platform to perform the sensing action and generate the first or second sensing signal. According to the first sensing signal, the control unit drives the rotary platform to rotate and drives the sensing device to perform the 3-D scanning task on the object. According to the second sensing signal, the control unit controls the sensing device to rotate to face the rotary platform, so as to perform the 2-D scanning task on the object. Hence, the scanner provided herein is able to automatically detect the object and determine whether the object is a 3-D object or a 2-D object, so as to perform the corresponding 3-D or 2-D scanning task. As a result, the use of the scanner is much more convenient.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A scanner adapted to perform a two-dimensional scanning task or a three-dimensional scanning task on an object, the scanner comprising:
a rotary platform having a carrying surface, the rotary platform being arranged to rotate about a rotation axis, the object being adapted to be arranged on the carrying surface;
a support rack, the rotary platform being located at one end of the support rack;
an adjustment mechanism located at the other end of the support rack opposite to the one end of the support rack where the rotary platform is located;
a sensing device arranged on the adjustment mechanism to generate a first sensing signal or a second sensing signal; and
a control unit coupled to the sensing device, the adjustment mechanism, and the rotary platform to drive the rotary platform to rotate according to the first sensing signal, to drive the sensing device to perform the three-dimensional scanning task on the object, or to control the adjustment mechanism to drive the sensing device to rotate by a specific angle according to the second sensing signal, such that the sensing device faces the carrying surface to perform the two-dimensional scanning task on the object.

2. The scanner as claimed in claim 1, further comprising a screen located at one side of the rotary platform, the screen and the support rack being respectively located at two opposite sides of the rotary platform.

3. The scanner as claimed in claim 2, wherein the sensing device is configured to rotate between a first location and a second location, when the sensing device rotates to the first location, the sensing device faces the screen, and when the sensing device rotates to the second location, the sensing device faces the carrying surface.

4. The scanner as claimed in claim 2, wherein when the object is located on the carrying surface, if the sensing device senses a change to an image of the screen, the sensing device generates the first sensing signal, and if the sensing device senses no change to the image of the screen, the sensing device generates the second sensing signal.

5. The scanner as claimed in claim 2, wherein the screen comprises a projection surface perpendicular to the carrying surface.

6. The scanner as claimed in claim 1, in the three-dimensional scanning task, the control unit further driving the rotary platform to rotate the object to a plurality of orientations and controlling the sensing device to capture a plurality of images of the object at the orientations respectively, so as to establish a digital three-dimensional model associated with the object according to the captured images of the object corresponding to the orientations.

7. The scanner as claimed in claim 6, wherein the rotary platform sequentially rotates by a plurality of predetermined angles about the rotation axis, such that the object is sequentially rotated to the orientations.

8. The scanner as claimed in claim 7, wherein a sum of the predetermined angles is 180 degrees.

9. The scanner as claimed in claim 6, wherein the control unit compares an initial image of the object corresponding to an initial orientation of the object on the rotary platform with a final image of the object corresponding to a final orientation where the object is rotated, so as to obtain a center axis of the images of the object.

10. The scanner as claimed in claim 2, further comprising:
a light source configured to emit a light beam in a direction parallel to the carrying surface, the screen being arranged on a transmission path of the light beam, the rotary platform being located between the light source and the screen.

11. The scanner as claimed in claim 10, in the three-dimensional scanning task, the control unit driving the rotary platform to rotate the object to a plurality of orientations to form on the screen a plurality of images of a silhouette of the object corresponding to the orientations, the control unit further controlling the sensing device to capture the images of the silhouette of the object, so as to establish a digital three-dimensional model associated with the object according to the images of the silhouette of the object corresponding to the orientations.

12. The scanner as claimed in claim 1, wherein the sensing device is a monochrome image sensing device.

13. The scanner as claimed in claim 1, in the two-dimensional scanning task, the control unit further controlling the sensing device to capture an image of the object, so as to establish a digital two-dimensional scan file associated with the object according to the captured image of the object.

14. The scanner as claimed in claim 1, further comprising:
a light source configured to emit a light beam in a direction parallel to the carrying surface.

15. The scanner as claimed in claim 14, wherein when the object is located on the carrying surface, if the sensing device senses reflection of the light beam, the sensing device generates the first sensing signal, and if the sensing device senses no reflection of the light beam, the sensing device generates the second sensing signal.
